(19) United States
(12) Patent Application Publication
(10) Pub. No.: US 2011/0076644 A1
(43) Pub. Date: Mar. 31, 2011

(54) Locking Ring

(75) Inventor: Fredrik Nils Engman, Molnlycke (SE)

(73) Assignee: NEOSS LIMITED, Yorkshire (GB)

(21) Appl. No.: 12/988,503

(22) PCT Filed: Apr. 17, 2009
(86) PCT No.: PCT/GB09/50382

§ 371 Date: Dec. 3, 2010

(30) Foreign Application Priority Data
Apr. 18, 2008 (GB) 0807113.6

(51) Int. Cl. A61C 8/00

(52) U.S. Cl. 433/174

(57) ABSTRACT

Various embodiments related to a locking ring for a dental implant assembly are disclosed. In one example, the locking ring is adapted at one end to engage with an implant screw, such as the head of the implant screw, and at an opposite end is adapted to engage with a dental prosthesis.

### FIELD OF THE INVENTION

The present invention relates to a novel locking ring for use in the field of dental implant technology.

In particular, but not exclusively, the present invention relates to a locking ring for use in conjunction with a spacer element used in dental implant technology and/or to a dental implant assembly comprising such a locking ring.

### BACKGROUND

In a dental implant assembly, it is desirable to have a fixing of some kind for fixing, inter alia, an abutment or a spacer element to a dental implant. Typically, the fixing is a screw known as an implant screw. This implant screw is not the same as the implant per se which is itself externally threaded.

Conventionally, a dental implant assembly comprises an abutment or spacer connected to an implant. Usually, the implant will be provided with a blind bore extending inwardly from one end, and the abutment, e.g., for a crown or dental prosthesis, will be provided with the implant screw and/or a centering collar for insertion into the blind bore of the implant.

Whilst such implants have been available commercially for some time and are generally successful, there remains a need to make such implant assemblies easier to manufacture and/or easier for a dental practitioner to implant.

Attempts have been made to improve on conventional dental implant assemblies. However, most such attempts have focussed on improving the effectiveness of the locking between the abutment and the implant and/or to reduce or minimise bacterial ingress into the blind bore of the implant.

Thus, for example, European Patent No. 1 427 348 to IMZ describes an implant assembly comprising a base (the implant) member and an abutment, whereby the base member is provided with a positive lock region and positive lock elements, i.e., for joining to the abutment, and a centering region. The abutment comprises a complementary positive lock section and a centering section, the positive lock elements of the positive lock region are arranged offset from the face wall of the base member. However, the positioning of the abutment with respect to the implant is still not an “instant” fit since it is necessary to correctly orient the abutment and/or spacer to the implant.

We provide a locking assembly which overcomes or mitigates the disadvantages of the prior art implant assemblies.

### STATEMENT OF INVENTION

Therefore, according to a first aspect of the invention there is provided a locking ring adapted at one end to engage with an implant screw and at the other end adapted to engage with a dental prosthesis.

Thus, the locking ring may be an annular ring, i.e., comprising a hollow cylindrical body with a side wall. The body will be provided with a first end, which, in use, will be adjacent the implant screw, and a second end which, in use, will be distal to the implant screw and adjacent the dental prosthesis, e.g., an abutment assembly. The first end may be provided with means for engaging with the implant screw and preferably for engaging with the head of the implant screw. Preferably, such engaging means will comprise a circumferential lip, i.e., an inwardly facing lip. In an especially preferred aspect of the invention, the inwardly facing lip is provided with an upwardly facing inclined surface which is adapted to form a snug fit with the underside of the head of the implant screw.

In most cases, a dental implant will be provided with a blind bore for engagement with the implant screw; in addition the implant is usually provided with an annular recess for housing the head of the implant screw. Thus, in a further preferred embodiment of the invention, the locking ring is dimensioned such that it will form a snug fit within this annular recess.

Alternatively, the annular ring may have a diameter which is less than that of the annular recess for the head of the implant screw. Such an arrangement facilitates the insertion of the locking ring into the recess. However, preferably the outer wall of the cylindrical body is provided with means of engaging with the annular recess. Preferably, such means is adapted to engage the internal wall of the annular recess of the implant. Although a variety of such means may be used, a simple engaging means is to provide the outer wall of the annular ring with a boss, protruding from the wall. Preferably, the boss comprises a circumferential ridge, although it will be understood by the person skilled in the art that such a ridge does not have to be continuous.

As hereinbefore described, the locking ring may comprise a hollow cylindrical body. The body of the locking ring may optionally be provided with one or more longitudinal slots. However, if, for example, the locking ring comprises a resilient material, then it is within the scope of the present invention for the slots to be absent. In use, such a resilient ring per se will be sufficiently flexible to expand over, for example, the implant screw and the locking of the ring will be facilitated by the resilience of the material. Alternatively, if the locking ring comprises a substantially rigid material, e.g., a metal or a rigid plastic material, provided with one or more longitudinal slots in the circumferential wall of the locking ring. The one or more longitudinal slots will allow an expansion of the locking ring enabling it to be pushed into position onto an implant screw. Alternatively, the locking ring may comprise a combination of a resilient material and one or more longitudinal slots.

Preferably, the locking ring is formed as an integral part of a dental prosthesis.

The dental prosthesis may comprise any arrangement that would conventionally be desirable to locate on or in a dental implant. For example, the dental prosthesis may be a dental abutment or a spacer element or a dental bridge. In a particularly preferred embodiment, the locking ring is integral to an angulated spacer element of the type described in our co-pending UK patent application number GB0807118.5.

The locking ring may be advantageously included in a dental prosthesis assembly, such as an abutment assembly or a spacer assembly. Therefore, according to a further aspect of the invention there is provided a dental abutment assembly comprising a locking ring as hereinbefore described and a dental abutment. The locking ring may preferably be pre-mounted on or in an abutment as hereinbefore described.

In yet a further aspect of the invention there is provided a dental spacer assembly comprising a locking ring as hereinbefore described and a dental spacer element. Thus, the locking ring may preferably be pre-mounted on or in a spacer element as hereinbefore described.

The assembly of the invention as hereinbefore described may also be provided in kit form. Therefore, according to a further aspect of the invention there is provided a dental abutment kit comprising a locking ring according to the invention and a dental abutment.

Alternatively, there is provided a dental spacer kit comprising a locking ring according to the invention and a dental spacer element.

In a yet further alternative, there is provided a dental implant assembly kit comprising a locking ring substantially as described above, a dental implant and optionally one or more of a dental abutment, a dental abutment screw, dental implant screw, a dental spacer assembly and optionally a driving tool. In another aspect of the invention there is provided a method of producing a dental implant assembly as hereinbefore described which comprises providing a dental abutment assembly or a dental spacer assembly and locating the aforesaid assembly with a locking ring as hereinbefore described onto an implant screw.

There is further provided a method of anchoring an implant abutment which comprises at least positioning said abutment, optionally with a spacer element, and a locking ring according to the invention onto an implant screw located in the implant.

In the anchoring method as hereinbefore described, the method may comprise anchoring in a patient or, alternatively, anchoring in a dental bridge or dental construction.

Furthermore, a dental bridge or dental construction comprising the implant assembly of the invention is novel per se. Therefore, according to an additional aspect of the invention there is provided a dental bridge or dental construction comprising one or more dental implant assemblies as hereinbefore described.

The invention will now be described with reference to the following drawings in which

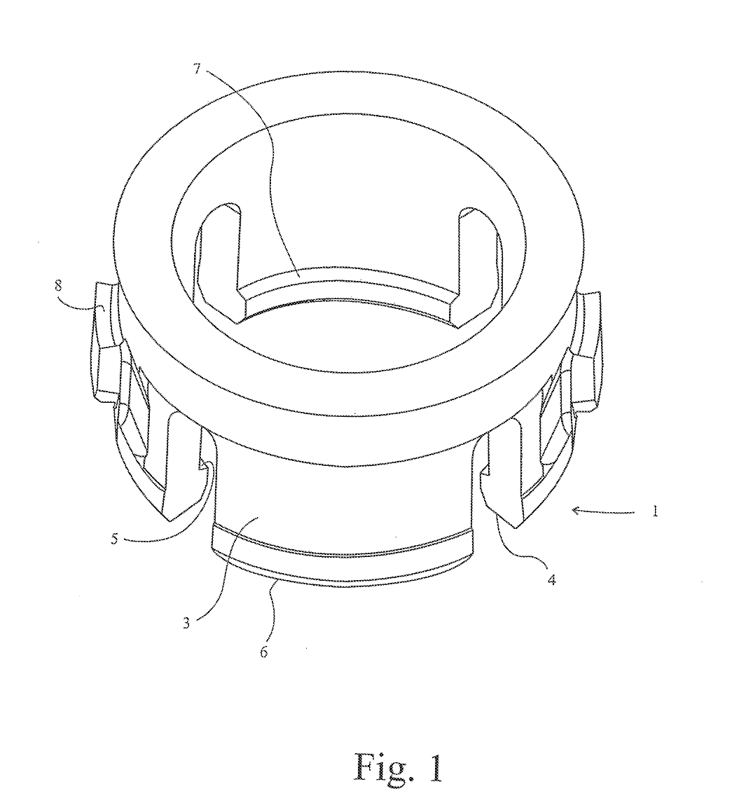

FIG. 1 is a perspective view of a locking ring embodying one aspect of the invention; and

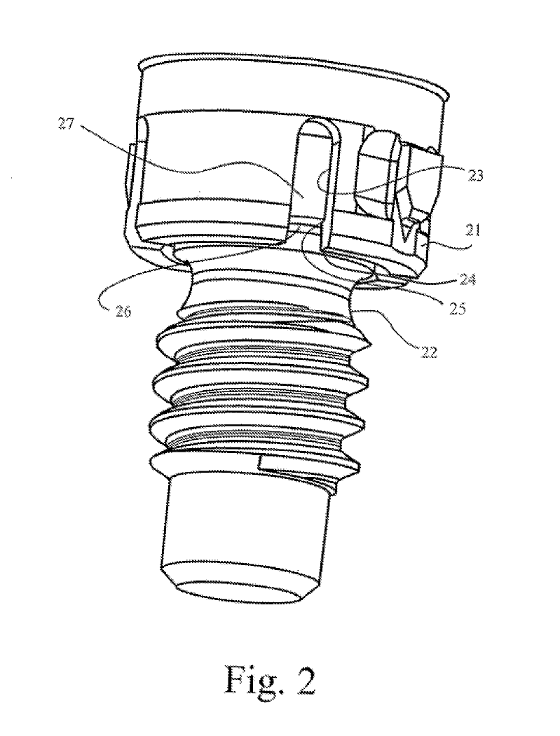

FIG. 2 is perspective view of the locking ring of FIG. 1 located on an implant screw.

Throughout the description and claims of this specification, the words “comprise” and “contain” and variations of the words, for example, “comprising” and “comprises,” means “including but not limited to,” and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

Referring to FIG. 1 the locking ring 1 is adapted to engage with an implant screw (not shown) and is optionally integrally connected to a spacer element (not shown). The locking ring 1 comprises an annular ring with side wall 3. Side wall 3 is provided with longitudinal slots 4 and a circumferential inwardly facing lip 5 at the end 6 of the annular ring which is, in use, adjacent the implant screw (not shown). The lip 5 is provided with an inclined upper surface 7 adapted to engage with the underside of the head of the implant screw (not shown). The side wall 3 of the locking ring is also provided with an external circumferential boss 8 which is adapted to engage with the inner surface of the annular recess of an implant (not shown).

Referring to FIG. 2 a locking ring 21 is located on an implant screw 22. The locking ring is provided with longitudinal slots 23 and inwardly facing lip 24, the inclined upper surface 25 of the lip 24 engages with the underside 26 of the head 27 of the implant screw 22.

Further structural modifications can be realised with respect to the exemplary embodiments described above.

The appended claims are incorporated by reference into the disclosure. All references, including publications, patent applications, and patents, cited herein are hereby incorporated by reference. The description or connotation, if any, of certain embodiments as “preferred” embodiments, and other recitation of embodiments, features, or ranged as being preferred, is not deemed to be limiting, and the invention is deemed to encompass embodiments that are presently deemed to be less preferred.

All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention unless otherwise claimed. Any statement herein as to the nature or benefits of the invention or of the preferred embodiments is not intended to be limiting, and the appended claims should not be deemed to be limited by such statements. More generally no language in the specification should be construed as indicating any non-claimed element as being essential to the practice of the invention. This invention includes all modifications and equivalents of the subject matter recited in the claims appended hereto as permitted by applicable law. Moreover, any combination of the above-described elements in all possible variation thereof is encompassed by the invention unless otherwise indicated herein or otherwise clearly contradicted by context. The description herein of any reference or patent or equipment, even if identified as “prior,” is not intended to constitute a concession that such reference or patent is available as prior art against the present invention.

1. A locking ring adapted at one end to engage with an implant screw and at an opposite end adapted to engage with a dental prosthesis.

2. The locking ring according to claim 1 wherein a first end is provided with means for engaging with said implant screw, preferably with a head of said implant screw.

3. The locking ring according to claim 2 wherein said engaging means is an inwardly extending circumferential lip.

4. The locking ring according to claim 3 wherein the inwardly extending lip is provided with an upwardly extending inclined surface.

5. The locking ring according to claim 1 wherein the locking ring is dimensioned to be capable of forming a snug fit within an annular recess of a dental implant.

6. The locking ring according to claim 1 wherein the locking ring has a diameter which is less than that of an annular recess of a dental implant.

7. The locking ring according to claim 6 wherein an outer wall of the locking ring is provided with means for engaging the annular recess of the dental implant.

8. The locking ring according to claim 7 wherein the means for engaging the annular recess of the dental implant comprises engaging means adapted to engage an internal wall of the annular recess of the dental implant.

9. The locking ring according to claim 8 wherein the engaging means comprises one or more bosses protruding from the outer wall of the locking ring.

10. The locking ring according to claim 9 wherein each of the one or more bosses comprises a circumferential ridge.

11. The locking ring according to claim 10 wherein each of the one or more bosses is a non-continuous ridge.

12. The locking ring according to claim 1 wherein the locking ring is provided with one or more longitudinal slots.

13. The locking ring according to claim 1 wherein the locking ring comprises a resilient material.

14. The locking ring according to claim 1 wherein the locking ring is integrally formed with a dental prosthesis such as a dental abutment or a spacer element or a dental bridge.

15. A dental spacer assembly including a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge.

16. A dental spacer kit comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge, and a dental spacer assembly.

17. A locking ring, spacer assembly or spacer kit adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge, and including an angulated spacer element.

18. A dental abutment assembly including a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge.

19. A dental abutment kit comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge, and a dental abutment.

20. A dental implant assembly comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge.

21. A dental implant assembly kit comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge, a dental implant, and optionally one or more of a dental abutment, a dental abutment screw, a dental implant screw, a dental spacer assembly and a driving tool.

22. The method of producing a dental implant assembly comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge, a dental implant, and optionally including one or more of a dental abutment, a dental abutment screw, a dental implant screw, a dental spacer assembly and a driving tool including the steps of providing a dental abutment assembly or a spacer assembly and locating the aforesaid assembly with the locking ring onto the implant screw.

23. A method of anchoring an abutment to an implant including positioning said abutment, optionally with a spacer element, and a locking ring onto an implant screw located in the implant, the locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge.

24. The method according to claim 23 which comprises anchoring in a patient or, alternatively, anchoring in a dental bridge or dental construction.

25. A dental bridge or dental construction including one or more dental implant assemblies comprising a locking ring adapted at one end to engage with an implant screw and at an opposite end adapted to engage with a dental prosthesis, and wherein a first end of the locking ring is provided with means for engaging with said implant screw, preferably with a head of said implant screw, the locking ring is dimensioned to be capable of forming a snug fit within an annular recess of a dental implant, the locking ring has a diameter which is less than that of the annular recess of the dental implant, and the locking ring is provided with one or more longitudinal slots, comprises a resilient material, and is integrally formed with a dental prosthesis such as a dental abutment or a spacer element or a dental bridge.

26. (canceled)
